(19) United States
(12) Patent Application Publication
(10) Pub. No.: US 2012/0233235 A1
(43) Pub. Date: Sep. 13, 2012

(54) METHODS AND APPARATUS FOR CONTENT APPLICATION DEVELOPMENT AND DEPLOYMENT

(76) Inventors: Jeremy David Allaire, Wellesley, MA (US); Ashley Streb, West Newbury, MA (US); Jesse John Philip Streb, Newburyport, MA (US); Jian Liu, Tewksbury, MA (US)

(21) Appl. No.: 13/042,044

(22) Filed: Mar. 7, 2011

(51) Int. Cl. G06F 9/44; G06F 15/16

(52) U.S. Cl. 709/201; 717/109

(57) ABSTRACT

A system efficiently generates template-based applications for interacting with digital content. The applications are available to multiple kinds of application platforms and can be installed and run on such platforms, thereby allowing users to access and interact with rich, multimedia content on the application platforms. The content delivered to the application platforms is also adapted according to the properties of these platforms.

### FIELD OF THE INVENTION

In various embodiments, the present invention generally relates to software applications utilizing digital content. In particular, the invention relates to the creation and operation of applications for receiving, sending, and displaying multimedia content on a variety of application platforms.

### BACKGROUND

More and more people in the United States and around the world are becoming Internet users, and those Internet users are changing the way they use and access the Internet. Many people now access the Internet using various application platforms such as mobile, hand-held devices (cell phones, personal digital assistants (PDAs), etc.) and digital-content display devices such as web-connected televisions. The nature of the content sought by users has also changed significantly, from simple text to multimedia content including images, audio, and video, streaming and otherwise. The demand for multimedia content is further fuelled by the use of powerful, web-enabled application platforms (e.g., iPhone, Android phones, BlackBerrys, tablets, etc.), that allow users to receive content virtually anywhere via a wireless connection.

With existing content-delivery methods, content providers usually provide a website where users can search for and view the content of their choice. A player (i.e., a software program) to access and view the content is present on the user's client device and may be, for example, embedded in a web browser used to interact with the provider's website. The player may be supplied by the content provider or a third party, and the player may be customized, e.g., according to attributes of the user (e.g., guest visitor, subscriber), the nature of the content itself (e.g., news bulletins, streaming video, educational lectures), etc.

This website-based system of content delivery presents several challenges when the content is viewed on an application platform (e.g., mobile devices, laptops, tablet computers, and web-connected televisions) for which it was not initially purposed. For example, cell phones and other hand-held devices may be used to access content on the Internet. The display screen of a mobile device is typically smaller than that of a desktop or laptop. Therefore, it can be difficult to view a webpage designed for a conventional computer on a mobile device. Navigating through the website can be cumbersome because the user must frequently zoom out to locate a desired section of the webpage, and then zoom in to view the displayed text and images.

Another problem arises if the connection to the Internet is unreliable. In some situations, even though the connection is not completely unavailable, the bandwidth or connection speed may vary substantially. A conventional content delivery system typically does not account for varying connection speeds or intermittent connections. As a result, the user may have to attempt to access the content several times.

One approach to addressing these problems is to provide access to the content via an application (e.g., software installed and executed on the user's device). The application typically allows the user to search for content, select desired content items, and view them on the device. The application is generally designed taking into consideration the physical properties of the device and the intermittent nature of the connections, and hence, the application can provide improved access to the content. Moreover, some applications enable users not only to receive content, but to create, send, and share content with other users.

An application-based system, however, also faces many challenges. First, different users (or the same user at different times) may access different types of content. For example, some users may view news articles, some may listen to songs, some may view live video, and some may access documents such as a manual or drawings. An application designed to deliver one type of content may not be able to provide access to a different type of content in an efficient and convenient manner. Furthermore, different types of application platforms employ different hardware and software, and hence, an application designed for one type of platform may not operate as intended on a different type of application platform. Accordingly, there is a need for improved systems and methods for the creation and deployment of applications that provide access to content.

### SUMMARY

In various embodiments, the present invention enables the creation of applications (e.g., software programs) that may be customized according to the type of content and services to be provided to the content users and the platforms used by the end users. The applications are generated substantially automatically for several desired types of application platforms without requiring the application creator to expend significant time or effort. This is achieved, in part, by supplying templates to application creators that are pre-designed and suitable for specific types of content. An application is built by specifying certain basic information, and the template is automatically transformed into one or more applications that can be installed and executed on a variety of different application platforms. Each application may be automatically customized according to the properties of the content-access system such as its hardware infrastructure (processor type, available memory, etc.), software platform (operating system, etc.), and other properties (connection speed, accessible content formats, etc.) Application creators can also create their own templates and store them in a database for later use.

An application may allow users not only to receive content but also to interact with it. To illustrate, a user may receive a message through the application requesting the user's picture. In accordance with the user's direction, the application may access a camera on the user's display device and create a picture. Then, using the application, the user may share it with other users. Thus, the applications typically facilitate reception, creation, and distribution of content. An interactive application can also allow a content provider to seek feedback from content viewers, and the viewers may provide such feedback using the application. Typically, a template facilitates the creation of applications that allow users to create and interact with content.

Optionally, various components providing different functionalities are added to the application. In addition to providing access to the content, the components allow for the measurement of various usage data associated with the access to the content, fast and secure payment for the content, and location-based services using features of the display device. These functionalities can also be used to optimize content delivery, thereby enriching the users' experience accessing the content. Components suitable for a specific type of content may be included in templates. Other components can be added to templates from a library.

Once the application is built, the content provider can specify at least one target platform, and an application installable and executable on the specified target platforms is automatically generated. The application is then published, i.e., distributed and delivered to the user's display device. This can be done using a third-party distribution channel such as a device maker's or wireless service provider's store or website. In operation, the application accesses information from the display device such as signal strength, available memory, and available bandwidth. Using this information, the application can adapt content-delivery policies such as caching and compression to reduce service interruptions experienced by the user.

Accordingly, in a first aspect, embodiments of the invention feature an apparatus for the creation, publication, management, and operation of applications for execution on an application platform. The apparatus includes a network interface for the transmission and receipt of data, and a database that includes a plurality of application templates. At least one application template in the database is customizable to refer to a network-accessible media content. The apparatus also includes an input device permitting the selection of an application template from the plurality of application templates stored in the database. The apparatus also allows for the designation of a network-accessible media content in connection with the selected application template. Moreover, the apparatus includes a publication module configured to generate a plurality of applications, such that each application is executable by a different kind of application platform using technologies native to the application platform. Each generated application is based at least in part upon the selected application template and the designated network-accessible media content.

At least one application generated using the apparatus may be a self-contained application or network-connected content application. In some embodiments, at least one of the plurality of application templates includes components, custom logic, and a manifest file. The network interface of the apparatus may be utilized to transmit at least one generated application, or to make a copy of the network-accessible media content on a server by loading the network-accessible media content, or both. The network interface of the apparatus may be further configured to optimize a media content for a particular kind of application platform prior to delivering that media content to an application platform of that particular kind. In some embodiments, the database of the apparatus is configured to receive an application template for addition to the plurality of application templates.

In a second aspect, embodiments of the invention feature a method for the creation of applications for execution on an application platform. The method includes providing a server having a network interface and hosting a plurality of application templates. At least one application template is customizable to refer to a network-accessible media content. The method also includes receiving, at the server, a selection of an application template from the plurality of application templates, and a designation of a network-accessible media content in connection with the selected application template. Additionally, the method includes generating a plurality of applications, such that each application is executable by a different kind of application platform using technologies native to the application platform. Each generated application is based at least in part upon the application template and the designated network-accessible media content.

At least one application generated according to the method may be a self-contained application or a network-connected content application. In some embodiments, at least one of the plurality of application templates hosted according to the method includes components, custom logic, and a manifest file. The method may include transmitting at least one generated application utilizing the network interface, or making a copy of the network-accessible media content on the server by loading the network-accessible media content utilizing the network interface, or both. The method may also include receiving, at the server, an application template for addition to the plurality of application templates, or optimizing, at the server, a media content for a particular kind of application platform prior to delivering that media content to an application platform of that particular kind, or both.

In a third aspect, embodiments of the invention feature an article of manufacture storing computer readable instructions thereon. The stored instructions are used for the creation of applications for execution on an application platform. The article of manufacture includes instructions for a plurality of application templates, with at least one application template customizable to refer to a network-accessible media content. The article of manufacture also includes instructions for receiving a selection of an application template from the plurality of application templates, and instructions for receiving a designation of a network-accessible media content in connection with the selected application template. Additionally, the article of manufacture includes instructions for generating a plurality of applications, such that each application is executable by a different kind of application platform using technologies native to the application platform. Each application generated according to the instructions is based at least in part upon the application template and the designated network-accessible media content.

The article of manufacture may include instructions such that at least one generated application is a self-contained application or network-connected content application. In some embodiments, at least one of the plurality of application templates according to the instructions stored in the article includes components, custom logic, and a manifest file. The article of manufacture may further include instructions for transmitting at least one generated application utilizing a network interface, or making a copy of the network-accessible media content on the server by loading the network-accessible media content utilizing a network interface, or both.

In some embodiments, the article of manufacture includes instructions for receiving an application template for addition to the plurality of application templates, or optimizing a media content for a particular kind of application platform prior to delivering that media content to an application platform of that particular kind, or both.

In a fourth aspect, embodiments of the invention feature a method for interacting with a content-provisioning system. The method includes providing an application executing on an application platform, and upon execution of the application, retrieving, utilizing a network interface, information concerning the execution of the application. Retrieving information according to the method may include retrieving at least one content item satisfying at least one rule. In some embodiments, the method may include updating the at least one rule, and retrieving at least one content item according to the updated rule. The at least one rule may include a rate at which the content items are retrieved.

These and other objects, along with advantages and features of the embodiments of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 schematically shows various parts of an embodiment of an application development system in accord with the present invention;

FIG. 2 shows an exemplary process of creating a template-based application;

FIG. 3 provides an overview of the various functions of an embodiment of the application development system; and

FIG. 4 schematically shows an exemplary template.

### DESCRIPTION

As used herein, the term “application” generally means a software program that can be executed on an application platform, e.g., a mobile device such as an iPhone, BlackBerry, etc or web-connected television, tablet computer, etc. An application typically allows a user to interact with content received either through a content provider's intermediary system, such as Content App Platform (CAP) offered by BRIGHTCOVE of Cambridge, Mass., or directly from a remote repository using a display device such as a mobile phone, network-connected television, etc. Applications can customize and enrich a user's experience in interacting with (e.g., searching, reading, listening, viewing, creating, sharing, etc.) content.

As used herein, the term “application platform” or “platform” describes a variety of hardware and/or software systems that support content applications, including: mobile OS platforms such as Android, iOS, Blackberry OS, Windows Mobile; mobile devices such as smart phones & tablets; mobile web browsers; Internet-connected TVs such as Google TV; and social media platforms such as Facebook.

In one embodiment, the application development system 100 includes a database of templates 102 (also called a library of templates) residing on a server. A template is a package of at least one application file and a manifest file that provides information required for generating an application based on the template. Typical template information includes the template name, its visual representation, and sections. A visual representation may include a skin (i.e., background) for the application, color of the skin, etc. One or more displayed sections of an application can provide convenient access to different functions. For example, in an application for accessing news, one section may display news from a commercial news service and the other section may provide interactive access to user-shared news such as postings on Twitter.

A template may be customized to include various types of content to be accessed using the application ultimately created from the template. For example, some templates are designed for accessing streaming media content, while others are customized for accessing discrete music or video files. Some templates are customized according to the nature of the application, such as marketing, media, e-commerce, education, non-profit, and small business applications. Starting application development from a template that already includes the application files needed to create a certain type of application can simplify and expedite the process of creating a new application. It should be understood that the types listed above are illustrative only, and that templates suitable for other types of content and applications may be included in the template database 102.

A developer initiates the process of creating an application by selecting a template from the database 102. Some templates in the template database 102 may be accessible to all developers while other templates may be accessible to only a subset of developers. The developer may search among the accessible templates via a user interface (UI) 104 and select a template suitable for the required application. For the selected template, the developer optionally supplies additional details using the UI 104. The additional details can include certain information such as the name of the application, the target display device platforms, and a theme determining the colors, font, and styling of an application.

Using the UI 104 the developer may also select content items to be provided and a style in which the items are provided. For example, the content items can be news articles, songs, or streaming video. In one embodiment of the system 100, the content items may be stored locally in a content database 106 for subsequent delivery to users. Aspects of the system 100 provide different ways to organize, find, and discover content items within the database 106 or a remote repository 108. A view of the content is provided via the UI 104, where the content in a view is selected according a specified property of the content or a specified ordering, thereby limiting the results of a search.

The content items may be organized in a hierarchical collection structure using a rule set defining the content items that belong to the collection. A collection can effectively be implemented as a persistent view where membership in the collection is determined by content-attribute matching, ordering, and limiting. For example, a collection can be a set of songs by a certain artist. If that artist produces a new song, the new song would also be added to the existing collection. A collection can be nested within another collection. Hierarchy in a nested collection may be implemented using traversable “match” rules. For example, in a business application, one rule would identify deals completed during a specified time period (e.g., a day, week, etc.). Another rule would identify deals associated with a specified product. The application of both rules would result in a collection of all deals related to a specified product that were completed during a certain time period.

The UI 104 may also enable the developer to include or associate network-accessible media content in the selected application template. The content characteristics may include the content type (e.g., text, audio, video) and other criteria such as the name of a content provider, a type of subscription service, etc. The UI 104 also allows the developer to include in the application one or more components from a component library 110. Each included component may be configured using the UI 104. Several exemplary components are described below.

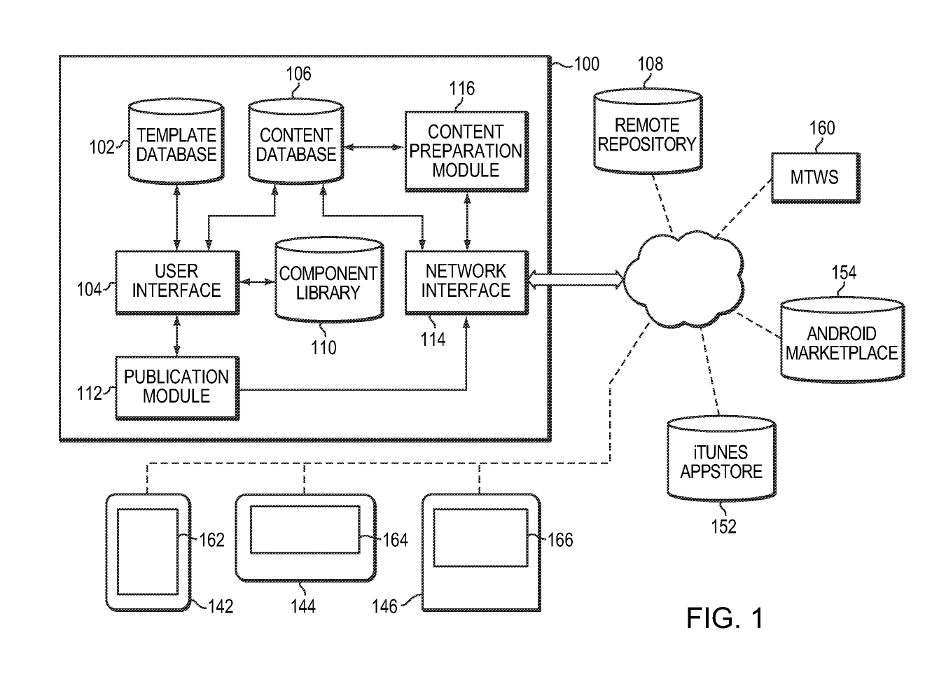

Based on the selected template, either in its original or modified form, a publication services module 112 first generates a base application. In order to be used on an application platform, the base application must be published, i.e., transformed into an application that can be installed and executed on at least one target application platform. FIG. 1 shows system 100 interacting with three target platforms, namely, an iPhone 142, an Android-based phone 144, and a web-connected television 146. It should be understood that these target platforms are illustrative only and that fewer (i.e., as few as one) and more target platforms, and platforms of other kinds (e.g., BlackBerry phones, mobile touch-web systems, tablet computers, etc.) are within the scope of the invention.

If the base application has not been published previously to a specified target platform, the publication services module 112 compiles the application for that platform. If the publication services module 112 has already published the base application then the developer can recompile and republish the application to provide updates such as updated component configuration or application-feature updates to the users who have already installed the application. During the process of publishing or republishing, the developer selects one or more target platforms for which the application is to be compiled. For each selected target platform, compilation options specific to that platform are displayed and the developer may select one or more of these options via the UI 104. For example, if the target platform is the iPhone, the developer is provided with the option to upload a “splash screen” and an application thumbnail.

After a base application is published, the system 100 may display and identify the currently published applications, the applications that have been developed but not published, and the applications that are currently being developed. The recently published applications may be highlighted. Additional information about the published applications, such as the total number of application downloads, the average number of application instances executing during a certain time period, etc. may also be displayed by system 100.

In one embodiment of an application development system in accord with the present invention, an application-preview module (not shown) included in the system simulates a user's experience in running the application on an application platform. For this, a full image of the application as it would be viewed by a user when it is run (i.e., executed) on a target display device is presented to the content provider via the UI 104. The image is adjusted to provide a display corresponding to the execution of the application on a particular kind of target platform, e.g., iPhone, Android-based phones, BlackBerry, web-connected televisions, laptops, tablet computers, etc. During preview the developer may interact with the application by selecting one or more control features provided by the application. To simulate the mobile touch experience, a finger shape may be provided as a mouse arrow cursor, and using the finger shape various features of the application are selected. Accordingly, the developer can view a substantially complete “look and feel” of an application before publishing it.

A published application may be a self-contained application that includes both an executable component and the content items that may be accessed using the application. Typically, these content items are obtained from the content database 106 at development time, as described above. The published application may also be a network-connected content application that includes both an executable component and links or addresses specifying associated content designation, as described above. A network connected content application, when installed on an application platform, can access content from system 100 or network-connected media sources such as remote repository 108. An application may be self-contained and at the same time act as a network-connected content application for associated media items.

In one embodiment, system 100 delivers published applications and content using a network interface 114. Prior to content distribution, a content-preparation module 116 detects or has a record of the target platform type, its form factors (e.g., screen dimensions), and other capabilities (e.g., RAM size, buffer size, codecs, etc.). Then, the content-preparation module 116 optionally transcodes the content (audio, video, photo) based on platform capabilities. Transcoding allows a content provider to supply content to system 100 in a format of the provider's preference, and subsequent processing adapts the content to a format that would be accepted by the user's application platform or circumstances (e.g., bandwidth, connectivity, etc.). The content-preparation module 116 may also search for content according to the specified rules and select updated or new content for delivery, on an on-going basis. By contrast, a published application is typically delivered to a target content-access system only once, unless the application is changed or updated, and hence, is republished.

The system 100 may also receive content from various content providers or the remote content repository 108 via the network interface 114. The received content may be stored in the local database 106 and may also be delivered to application platforms running network-connected content applications. Although system 100 depicts only one local content database 106 and one remote content repository 108, systems comprising more local databases or remote repositories, and systems not including a local database or remote content repository are within the scope of the invention.

When content is delivered to application platforms running network-connected content applications, the content-preparation module 116 in the system 100 may optionally transcode the content at the time of delivery. The content-preparation module 116 can also perform data compression, caching, and synchronization enabling users to access content when their connection to the Internet is temporarily unavailable or is unreliable so that the users' access to the content is substantially uninterrupted. The content-preparation module 116 can also provide a search engine plug-in (e.g., Google and/or Bing real-time search). In the system 100, the UI 104, the publication services module 112, the network interface 114, the content-preparation module 116, and the application-preview module, if included, are executed on a processor. In other embodiments, one or more of these system components may be executed on one or more processors or servers.

The published applications and content may also be delivered to application platforms indirectly using, e.g., a third party application store. For example, applications may be provided to iPhone devices 142 using the Apple's App Store 152, to Android devices 144 using the Android Market 154, and to various other platforms including BlackBerry devices, Windows Mobile devices, and Symbian devices, using suitable stores. As described above, the application may be delivered only once, but the content is typically delivered on an on-going basis. For indirect delivery, the network interface 114 transmits the published applications, content, or both to a store associated with a target application platform. The applications and content may also be distributed to a “mobile touch” web site (MTWS) 160 for ultimate delivery to mobile devices using a touch-enabled browser. Publishing the application to a “mobile touch” web site includes optimizing the application for touch user interface (UI) gestures.

An authorized user having a client device corresponding to the target platform may download, install, and run the published application on his or her device. The published application may be accessed from a third-party store. The user can be authorized, for example, by comparing an identification number (ID) associated with the display device with IDs stored in a database of authorized users.

As described above, an application can also directly receive the designated content without involving system 100. In particular, content from one or more remote repositories 108 can be accessed by applications 162, 164, 166 installed on the application platforms 142, 144, 146 by connecting to the remote repositories 108 using technologies such as RSS, MRSS, JSON REST, and plug-ins that can connect to third-party content providers such as Facebook and YouTube. When content is accessed directly from the remote repositories 108, features such as transcoding and data compression may not be available.

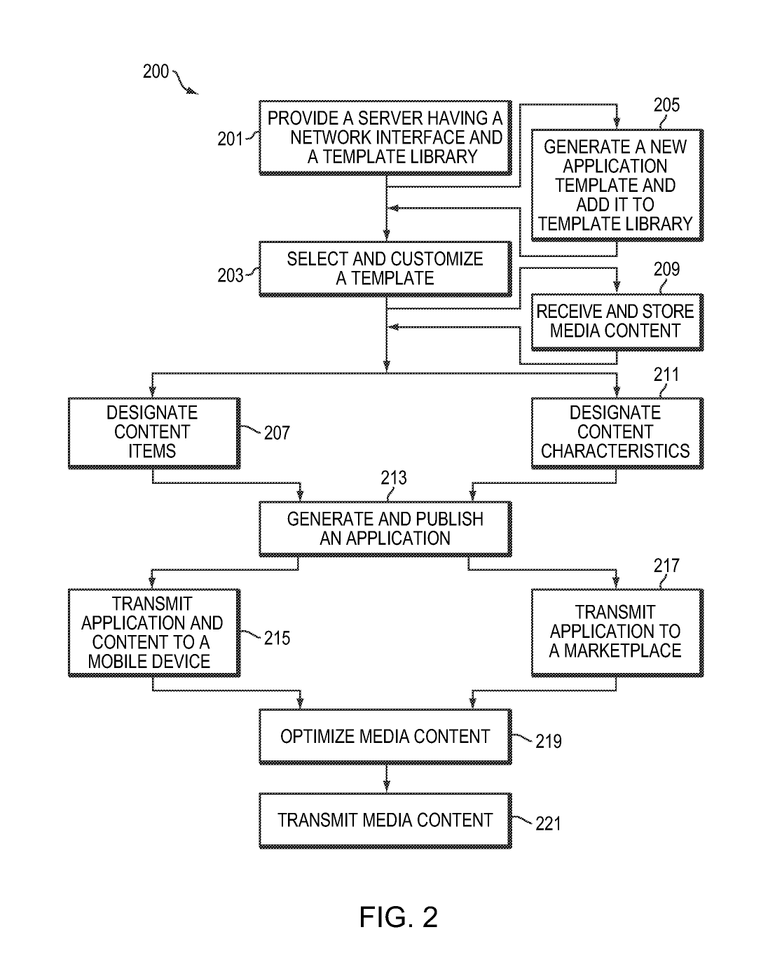

With reference to FIG. 2, in one embodiment depicted as a process 200, applications and content can be delivered to users by providing, in step 201, a server including a network interface and a template library. The server may include one or more server computers in communication with each other. The network interface is used to transmit an application created by the server, content associated with the application, or both to application platforms. The template library stores templates customized (i.e., designed) for various kinds of business purposes or content types, as described above with reference to FIG. 1.

In step 203, a developer selects a template suitable for the required application. The selected template may be further customized, if required, e.g., by adding one or more components that provide additional functionality to the application. Additional customization of an application template is described below. Optionally, in step 205, the developer can create a new template (e.g., a template designed for a new content type created by the developer) and store it in the template database at the server.

In step 207, content items are selected from a content database located at the server, and associated or included with the selected template. Additional content items may be utilized via the network interface from one or more remote repositories or content providers, or stored in the local content database in step 209. In step 211, the characteristics of a content item are set in the selected template as described above with reference to FIG. 1. Although the illustrated process 200 includes associating and including selected content items and setting content characteristics, a process performing only one type of designation is within the scope of the invention. The content items selected in step 207 are typically accessible via a network.

An application based on the selected template (in its original or customized form) is generated in step 213. The application is then published, i.e., compiled for the target platforms to which the application is delivered. The resulting applications include an executable component that is based, in part, on technology native to the application platform, e.g., WebKit, Objective-C, HTML, Java, etc., on various mobile or network-connected devices.

In step 215, the published application is transmitted via the network interface to one or more application platforms for which the application was published. The content included in the template in step 207 is also formatted according to the properties of the application platform and transmitted to the platform with the executable component of the application. When necessary, the content may also be transcoded according to the properties of a target application platform. In step 217, which may be performed in addition to or in lieu of step 215, the published application and content are delivered using the network interface to a third-party store, as described above with reference to FIG. 1. Steps 215, 217 are optional.

When content is associated with an application instead of being included in the application, then that content may not be delivered to the application platform when the published applications are transmitted in steps 215, 217. Instead, the content may be delivered at a later time (e.g., according to a schedule or when the user runs the application on the application platform). At the time of delivery, the server may optimize the content in step 219 and then deliver the optimized content in step 221. Content optimization can include performing data compression, caching, and synchronization, enabling users to access content when their connection to the Internet is temporarily unavailable or is unreliable so that the users' access to the content is substantially uninterrupted. The optimization in step 219 can also include modifying the content for touch user interface (UI) gestures, if the application is published to a mobile touch website.

As described above, a template can be customized to allow convenient access to particular items of content. A content type can include custom fields of simple and complex types. A simple type is a field whose value is a scalar type (e.g., string, date, number, etc.) and a complex type can be a list, map or other object type. Particular content items are instances of these content types. The system 100 depicted in FIG. 1 supports different content types such as news articles, event, XML stream, audio, video, images, maps, and real-time content types such as RSS feeds and YouTube channels. A developer may also create and upload new content types using a separate media manager program (not shown). For example, a new content type—“product”—may include other pre-existing content types such as text, maps, images, videos, and a price value. A developer can also share new content types with other developers. Content types can be associated automatically or manually with an application designed to provide access to that type of content.

Referring to FIG. 1, in addition to using existing templates from the template database 102, developers can create their own templates in a template-creation module (not shown) and upload them into the template database 102. A template is typically uploaded as a bundle of application source files, e.g., computer instructions written in languages such as HTML, JavaScript, CSS, etc., that may be compiled and/or interpreted. The bundle may also include metadata files specifying additional information about the application, such as the template name, description, template category, upload timestamp, and a list of screens including the name of a screen, its icon, a thumbnail capture of the screen, and the HTML filename for the bundle. Upon uploading a new template, the system 100 extracts, parses, and validates the metadata.

As described above, the functionality of an application can be enhanced by optionally included components. A component provides additional visual or non-visual functionality to an application, such as delivery of advertisements, processing of payments, and collection of usage data. Some components personalize content to a particular user based on device capability, network capability, demographic information, browsing information, user location, etc. To illustrate, the weather information displayed to a user would change depending on whether the user is in Boston or San Francisco. Similarly, the advertisements for restaurants delivered to a user's display device can change according to the user's browsing history. In some embodiments, the content-customization functionality is provided directly in a template, or in an intermediary platform, such as the system 100 shown in FIG. 1.

The components typically have properties that can be configured and associated with a content type, and these properties allow the integration and invocation of components within an application when it is run on a target platform. Components can be written in languages such as JavaScript, CSS, and HTML, and may be shared among different templates. Component templates such as a photo slideshow, news feed, Twitter feed, video library, real time video stream, audio library, real time audio stream, sharing control, and map may also be provided. One or more components may be configured and added to an application using the UI 104.

One component—a “monetize” component—allows developers to generate revenue through advertising and sales. In particular, the monetize component enables integration of the application with the leading ad servers and networks such as AdMob, iAds, FreeWheel, ScanScout, Tremor, MillenialMedia, AdWords, 4Info, and Medialets. An advertisement-performance optimization feature can optimize the selection of ads from various ad networks according to a specified profile.

Another component facilitates in-application micropayments. The application may be integrated with services such as PayPal, Amazon Pay, Google Checkout, and Android payment gateway. Social-media components can provide access to social media such as Facebook, Google Buzz, Twitter, etc., enabling users to share the content they have accessed with other users.

A measurement component provides analytical tools enabling developers to analyze and optimize performance of an application. Specifically, the developers can define key performance indicators (KPI), track usage patterns and generate usage reports. The user-related data in the usage reports may include (but are not limited to) the number of installations of an application, the number of times the application was executed, the maximum and average number of users, the numbers of new and returning users, the maximum and average time spent running an application, the maximum and average time spent accessing certain content, etc. The reports may also include information such as the type of the application platform, its operating system (OS), and the Internet service provider (i.e., the carrier) associated with the display device. The developers may choose and customize the reports according to their needs using a user interface.

The measurement component can also provide access to other analytical systems provided by third parties such as Google Analytics, MixPanel, and Localytics. Developers may customize the measurement component so that it may be integrated with existing analytical systems, or the developers may build a new analytical engine within the measurement component. The measurement component may also allow for testing of the application.

Using these different reports, developers can gain insight into how users interact with digital content on various platforms and how they choose between touch web (i.e., websites with which a user may interact using hand gestures, such as tap or squeeze, instead of using the conventional point-and-click devices) and installed applications. This information can be used to adapt the applications and websites, improving the users' experience accessing the content and increasing the application developer's potential return on investment.

The installed application is run on the application platform using a container model. Logically, the runtime environment of an application includes three parts: a container, a JavaScript bridge API, and application logic. The template creator typically provides the application logic when the template is created and the application-creation module 104 provides the container and the JavaScript bridge API. The application logic provides the content-access presentation and business functionality of the application. The container is a native wrapper (i.e., a software system) in which the JavaScript bridge API and the application can be loaded and executed. The container provides context for the application and the JavaScript bridge layer, and provides native presentation (i.e., display of content and the application for the display device), data caching, synchronization, installation, and updating of the application on the display device. The container may be written in a native platform language such as Objective-C, Java, HTML5, etc.

The JavaScript bridge layer provides a mapping from the display device's operating system (OS), also called the native OS, to the application in a platform-agnostic manner. This enables an application developer to write an application without requiring any platform-specific information and have it run on any platform. The application, which is included in the template as described above, is typically written in a language such as HTML, CSS, or JavaScript. An application may access the native capabilities of the application platform on which the application executes using the JavaScript Bridge layer. The examples of native capabilities include touch screen, camera, local storage, location determination, GPS, accelerometer, etc. The integration of these capabilities into the application can enhance the user's experience in accessing the content.

When an application runs on a target platform, it can cache retrieved data so that the content can be viewed without further retrieval. New content can then be fetched in the background while previously cached content is being displayed. Moreover, if a content provider changes the content, access policy, or application style while an application is running, those changes can be reflected in the running application. For this, the application loads the changes in the background and makes them visible at an appropriate time without interrupting the application to load and show the changes.

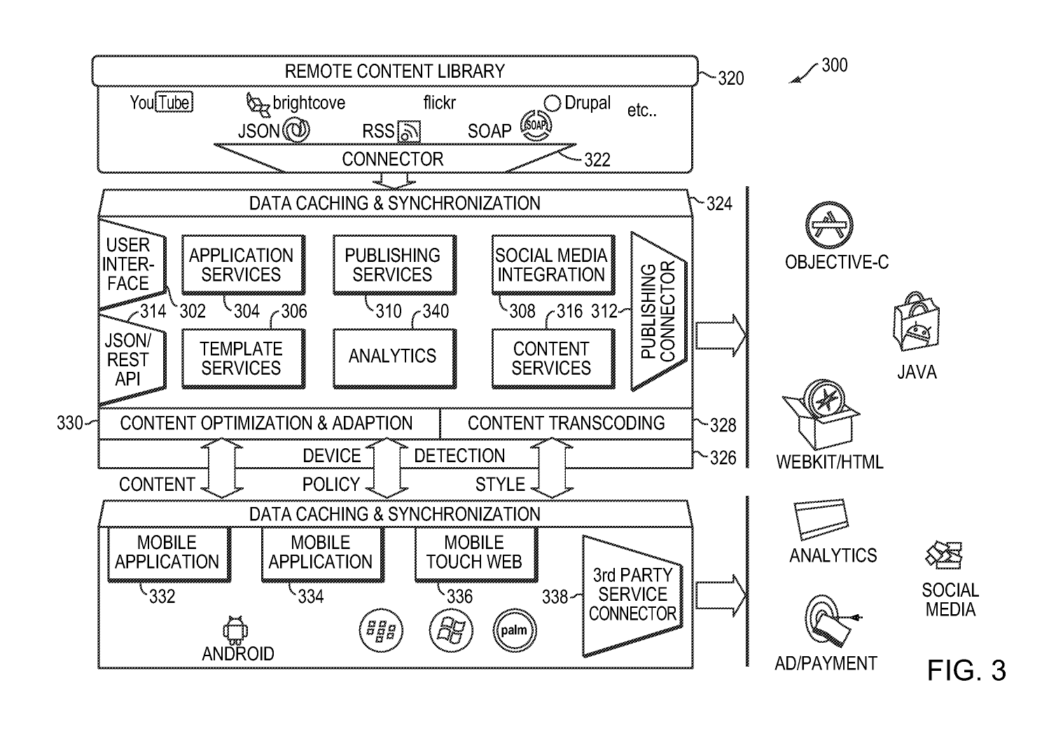

The various functions performed by the system 100 illustrated in FIG. 1 are summarized in FIG. 3. A developer interacts with modules 304-340 of the system 300 via a user interface 302. The application services module 304 interacts with the template services module 306 and allows the developer to select a suitable template for application development as described above with reference to FIGS. 1 and 2. The application services module 304, the template services module 306, or both provide additional components, if required, to generate an application. The social media integration module 308 provides application components to permit the integration of the application with various social-media services.

The publishing services module 310 cross-compiles the application into executable applications for the desired application platforms. The publishing connector module 312 distributes the executable applications to the desired platforms either directly or indirectly using, e.g., a third-party application store. In one embodiment, the publishing services module 310 and the publishing connector module 312 are included in the publication services module 112 of FIG. 1. The executable application is native to the platform, using a platform specific technology such as Objective-C, Java, WebKit/HTML, etc.

The template services module 306 also enables developers to create custom templates using the user interface module 302 and the JSON/REST API 314. The content services module 316 allows the developer to manage the content that may be accessed by the users and also facilitates creation of new content types as described above with reference to FIG. 1. Content can be stored in a local database (not shown) or remotely in a remote content library 320. Live and streaming content from the remote content library 320 is accessed via a connector 322 using methods/protocols such as JSON, RSS, and SOAP. The content received by system 300 is cached or synchronized using the data caching and synchronization module 324. This allows users to view content in a substantially uninterrupted manner even when the connection to the remote content library 320 is temporarily lost or is unreliable.

The device detection module 326 determines the type of the application platform (e.g., Android-based phone, iPhone, BlackBerry device, Windows Mobile device, PalmOS device, tablet computer, web-connected television, mobile web browser, etc.) to which the content is to be delivered. The content transcoding module 328 transcodes the content according to the bandwidth and latency of the connection to the application platform. The content optimization and adaptation module 330 modifies the content according to the display features (e.g., display size, form factor, etc.) of the application platform. The content, along with an access policy and presentation style, is delivered either to an application 332 installed on an application platform, incorporated into an application 334 prior to distribution, or to a “mobile touch” web site 336. The installed application 332 can also perform data caching and synchronization so that the user can access the content in a substantially uninterrupted manner.

Various components included in the installed applications 332, 334 can invoke third-party service connectors 338 and perform additional functions such as payment, usage-data analysis, and sharing content on social media networks. Some components can monitor various content-usage data and user-behavior data and communicate these data to the analytics module 340. Developers can access the analytics module 340 via the user interface 302 and generate various usage reports, as described above, to adjust and enrich content delivery.

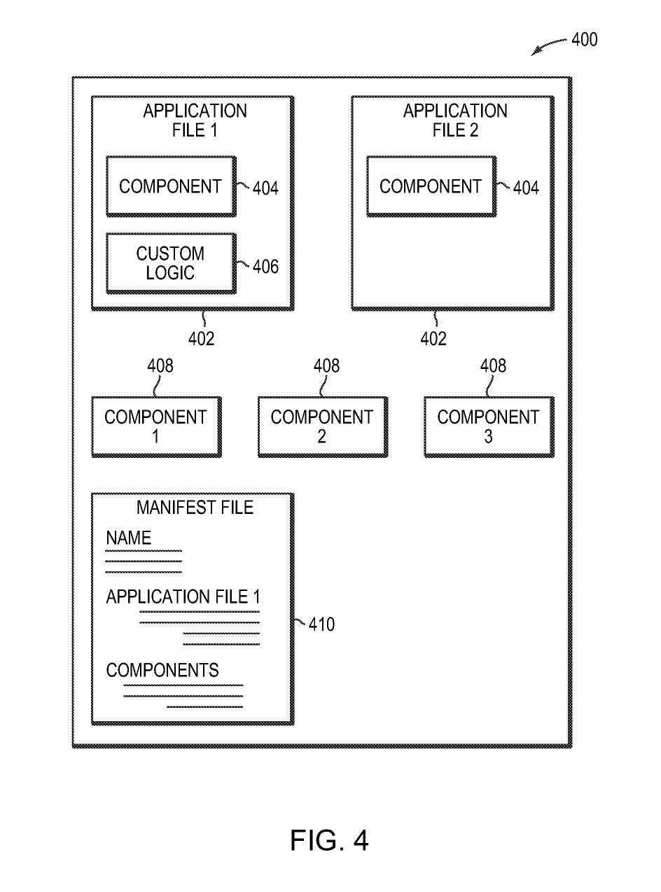

With reference to FIG. 4, in one embodiment a template 400 includes application files 402. The application files include components 404 and custom logic 406. The components 404 may provide core functionality relating to content access, content display, network access, user interface, etc., and the custom logic 406 can enable integration of components. The custom logic 406 is typically written in a language such as HTML, JavaScript, or CSS. The template 400 also includes additional components 408 that provide enhanced functionality (e.g., monetization, measurement, payment, analytics, etc.), as described above. The template 400 also includes a manifest file 410 that provides information such as name, visual representation, and sections.

In one embodiment of a method of operating a system according to the present invention, an application executing on an application platform interacts with a content-provisioning system. Referring to FIG. 1, the application-development system 100 may serve as the content-provisioning system. As described above, the system 100, using the network interface 114, may send content items such as news postings about a specified event to the application. Such information is usually sent on an on-going basis, e.g., as the event unfolds and more news items become available. The system 100 may receive additional news items, and sends those to the application via the network interface 114. A user running the application can also interact with the system 100. For example, the user may specify another event related to the previously specified event, and, in response, the system 100 may select and send news items related to both events.

The system 100 can also interact with an application developer. For example, the application developer may change the application background such as the background color, image, etc. In this case, the application need not be republished and reinstalled on the application platform. Instead, the system 100 sends the necessary information to the application so that the change specified by the developer is implemented on the application already installed or running on the application platform.

The developer may also change a rule, e.g., the rate at which advertisements are sent to the application is changed from every two minutes to every five minutes. Accordingly, the system 100 can change the rate at which advertisement content is delivered to the application. In some instances, the system 100 may collect information about the application user (e.g., user's location, content-viewing history, etc.) or the application platform (such as connection speed, platform update, etc.). An updated platform may support a content format that was previously unsupported. The system 100 may use this information to automatically update a content-selection rule or delivery format rule, and deliver content according to the update rule.

While the invention has been particularly shown and described with reference to specific embodiments, it will be understood by those skilled in the art that various changes in form and detail may be made therein without departing from the spirit and scope of the invention as defined by the appended claims. The scope of the invention is thus indicated by the appended claims and all changes that come within the meaning and range of equivalency of the claims are therefore intended to be embraced.

What is claimed is:

1. An apparatus for the creation, publication, management, and operation of applications for execution on an application platform, the apparatus comprising:
a network interface for the transmission and receipt of data;
a database comprising a plurality of application templates, with at least one application template customizable to refer to a network-accessible media content;
an input device permitting the selection of an application template from the plurality of application templates stored in the database, and the designation of a network-accessible media content in connection with the selected application template; and
a publication module configured to generate a plurality of applications, each application executable by a different kind of application platform using technologies native to the application platform and based at least in part upon the selected application template and the designated network-accessible media content.

2. The apparatus of claim 1 wherein at least one generated application is a self-contained application or network-connected content application.

3. The apparatus of claim 1 wherein at least one of the plurality of application templates comprises components, custom logic, and a manifest file.

4. The apparatus of claim 1 wherein the network interface is utilized to transmit at least one generated application.

5. The apparatus of claim 1 wherein the network interface is utilized to make a copy of the network-accessible media content on a server by loading the network-accessible media content.

6. The apparatus of claim 1 wherein the database is configured to receive an application template for addition to the plurality of application templates.

7. The apparatus of claim 1 wherein the network interface is further configured to optimize a media content for a particular kind of application platform prior to delivering that media content to an application platform of that particular kind.

8. A method for the creation of applications for execution on an application platform, the method comprising:
providing a server having a network interface and hosting a plurality of application templates, with at least one application template customizable to refer to a network-accessible media content;
receiving, at the server, a selection of an application template from the plurality of application templates;
receiving, at the server, a designation of a network-accessible media content in connection with the selected application template; and
generating a plurality of applications, each application executable by a different kind of application platform using technologies native to the application platform and based at least in part upon the application template and the designated network-accessible media content.

9. The method of claim 8 wherein at least one generated application is a self-contained application or network-connected content application.

10. The method of claim 8 wherein at least one of the plurality of application templates comprises components, custom logic, and a manifest file.

11. The method of claim 8 further comprising transmitting at least one generated application utilizing the network interface.

12. The method of claim 8 further comprising making a copy of the network-accessible media content on the server by loading the network-accessible media content utilizing the network interface.

13. The method of claim 8 further comprising receiving, at the server, an application template for addition to the plurality of application templates.

14. The method of claim 8 further comprising optimizing, at the server, a media content for a particular kind of application platform prior to delivering that media content to an application platform of that particular kind.

15. An article of manufacture storing computer readable instructions thereon for the creation of applications for execution on an application platform, the article of manufacture comprising:
instructions for a plurality of application templates, with at least one application template customizable to refer to a network-accessible media content;
instructions for receiving a selection of an application template from the plurality of application templates;
instructions for receiving a designation of a network-accessible media content in connection with the selected application template; and
instructions for generating a plurality of applications, each application executable by a different kind of application platform using technologies native to the application platform and based at least in part upon the application template and the designated network-accessible media content.

16. The article of manufacture of claim 15 wherein at least one generated application is a self-contained application or network-connected content application.

17. The article of manufacture of claim 15 wherein at least one of the plurality of application templates comprises components, custom logic, and a manifest file.

18. The article of manufacture of claim 15 further comprising instructions for transmitting at least one generated application utilizing a network interface.

19. The article of manufacture of claim 15 further comprising instructions for making a copy of the network-accessible media content on the server by loading the network-accessible media content utilizing a network interface.

20. The article of manufacture of claim 15 further comprising instructions for receiving an application template for addition to the plurality of application templates.

21. The article of manufacture of claim 15 further comprising instructions for optimizing a media content for a particular kind of application platform prior to delivering that media content to an application platform of that particular kind.

22. A method for interacting with a content-provisioning system, the method comprising:
providing an application executing on an application platform; and
upon execution of the application, retrieving, utilizing a network interface, information concerning the execution of the application.

23. The method of claim 22, wherein retrieving information comprises retrieving at least one content item satisfying at least one rule.

24. The method of claim 23, further comprising updating the at least one rule, and retrieving at least one content item according to the updated rule.

25. The method of claim 23, wherein the at least one rule comprises a rate at which the content items are retrieved. -
